(19) United States
(12) Patent Application Publication
(10) Pub. No.: US 2015/0199739 A1
(43) Pub. Date: Jul. 16, 2015

(54) METHOD AND SYSTEM OF INTERMEDIATED SALES

(71) Applicant: Mustafa Rasim KATI, Istanbul (TR)

(72) Inventor: Mustafa Rasim KATI, Istanbul (TR)

(21) Appl. No.: 14/151,814

(22) Filed: Jan. 10, 2014

(51) Int. Cl. G06Q 30/06; G06Q 30/02

(52) U.S. Cl. CPC G06Q 30/0617; G06Q 30/0214; G06Q 30/0643

(57) ABSTRACT

The present invention relates to a system and method for intermediated selling which facilitates communications among suppliers, virtual distributors and buyers and make commodity sales high efficiency and high profitable. A non-transitory computer-readable medium having embodied thereon a computer program configured to perform the method is also provided.

### FIELD OF THE INVENTION

The present invention relates to a system and method for intermediated selling which enables products and services to be sold and purchased by using electronic communication channels.

### BACKGROUND OF THE INVENTION

In techniques which are currently active in the market, a predetermined fixed commission is paid to distributors publishing products or services on the internet according to various models per sale or subscription. Suppliers start marketing products or services by sharing visual and text advertisements described by themselves in their sites. The distributors publish the advertisements in their sites or other platforms to direct visitors to suppliers' sites. Since each advertisement has specific link based on the campaign, the sales or subscriptions in such advertisement systems can be followed based on certain advertisement and campaigns. Distributors cannot choose which advertisement to be published and cannot intervene the content of the advertisement. Visitors reach the site of the supplier to view the products and decide to purchase or subscribe by filling the related forms. Upon sales or subscription is realized, a commission is paid to the related distributors. The distributors cannot intervene the commission rate, and the only factor for the profitability is the number of visitors directed to the supplier.

### SUMMARY OF THE INVENTION

The objective of the present invention is to realize a system and method for intermediated selling which enables facilitative communicate on among suppliers, virtual distributors and buyers and help commodity sales become highly efficient and highly profitable.

In accordance with one embodiment of the invention, a method for intermediated selling via an intermediary sales system, the method comprising the steps of:
making descriptions of products with base prices into a database; subscribing to the intermediary sales system;
creating a virtual storefront;
selecting products from the database to the virtual storefront;
determining a sale price calculated according to a commission over the base price;
outputting and publishing the virtual storefront to websites;
directing to the intermediary sales system while clicking on the website; and
providing business processes wherein a sales transaction is performed.

In accordance with one embodiment of the invention, a system for intermediary selling, comprising:
a database which is capable of storing details of products;
a supplier subscription unit which is capable of enabling suppliers to make descriptions of products into the database;
a virtual distributor subscription unit which is capable of enabling virtual distributors to access the database, select the products and create a virtual storefront and
a sales flow unit which is capable of providing business processes wherein sales transaction is performed.

In accordance with one embodiment of the invention, a non-transitory computer-readable medium having embodied thereon a computer program configured to cause the processor to enable perform the method of intermediary sales, the non-transitory computer-readable medium comprising one or more code segments configured the processor to:
enable suppliers to make descriptions of products into the database;
enable virtual distributors to access the database, select the products and create a virtual storefront and
provide business processes wherein sales transaction is performed.

### BRIEF DESCRIPTION OF THE DRAWINGS

FIG. 1 illustrates schematic view of the business model embodying the principle of the present invention.

FIG. 2 illustrates schematic view of the intermediary sales system embodying the principle of the present invention.

FIG. 3 illustrates flowchart of the method of intermediary sales embodying the principle of the present invention.

FIG. 4 illustrates schematic view of two sources for composing the products in the database embodying the principle of the present invention.

FIG. 5 illustrates flowchart of the products publishing from the ISS to website embodying the principle of the present invention.

FIG. 6 illustrates flowchart of commissions transfer embodying the principle of the present invention.

### DETAILED DESCRIPTION OF THE INVENTION

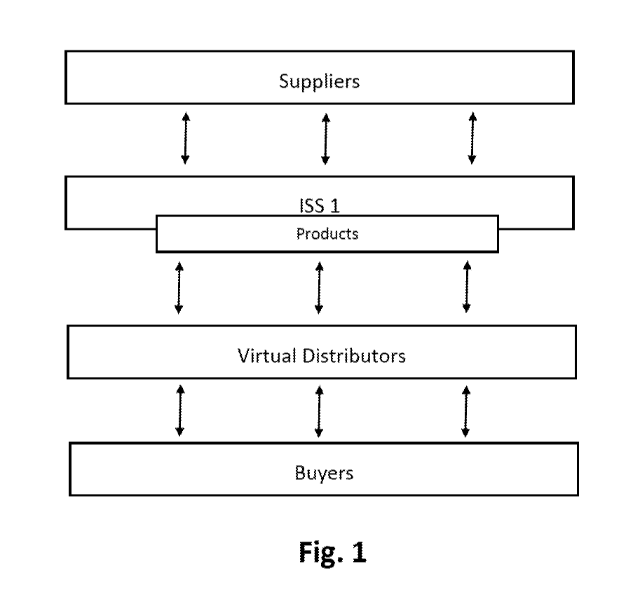

Referring to FIG. 1, a business model for marketing products or services on the internet via an intermediary sales system (ISS) 1 is shown. Participants of the business model include suppliers, virtual distributors and buyers, wherein the supplier is all institutions and people providing products or services, and the virtual distributor can be any person as well as a company who is able to increase sale and expand marketing channels as a sale partner by directing buyers to purchase products provided by suppliers. The ISS 1 facilitates communications among suppliers, virtual distributors and buyers and make commodity sales high efficiency and high profitable by managing supplier subscription, virtual distributor subscription and sales flow.

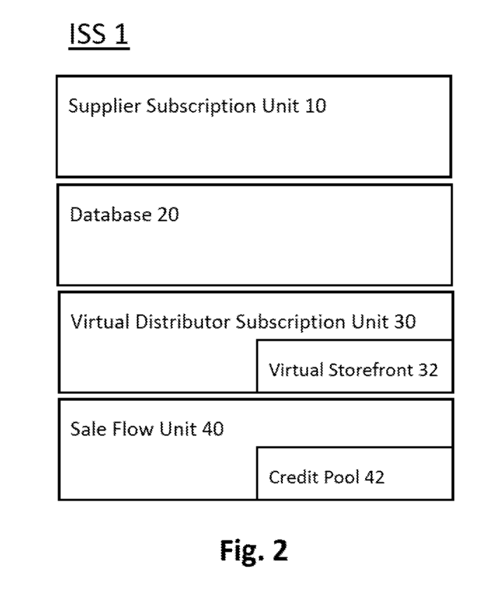

ISS 1 comprises supplier subscription unit 10, database 20, virtual distributor subscription unit 30 and sales flow unit 40, as shown in FIG. 2. Supplier subscription unit 10 enables suppliers to make descriptions of products into database 20. Database 20 is capable of storing details of products. Virtual distributor subscription unit 30 enables virtual distributors to access database 20, select products and create a virtual storefront 32. Sales flow unit 40 is capable of providing business processes wherein sales transaction is performed, and distributing profits through a credit pool 42.

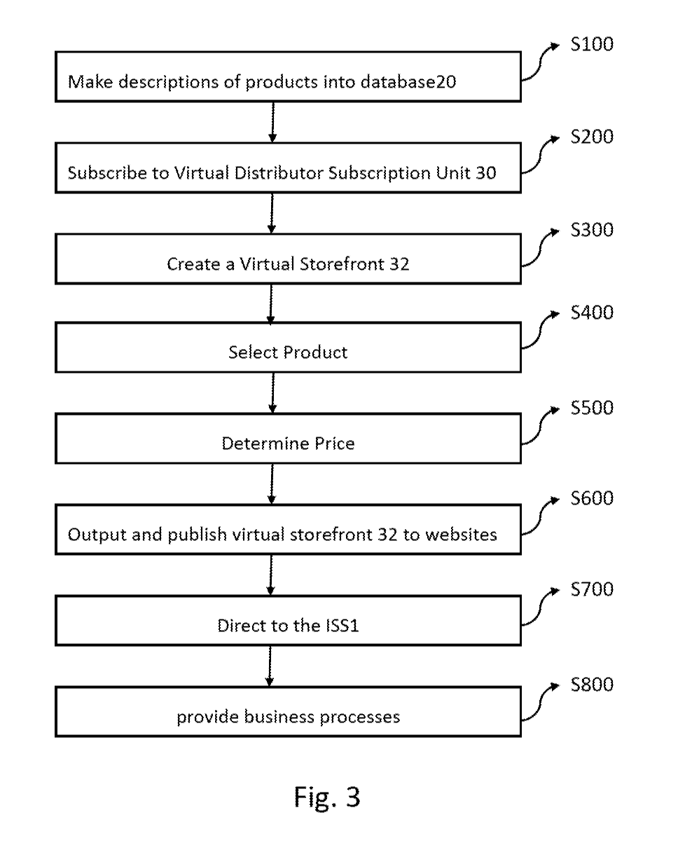

A method for intermediated selling via the ISS 1 comprises the following steps referring to FIG. 3:
S100: making descriptions of products with base prices into the database 20 by the supplier subscription unit 10;
S200: subscribing to the intermediary sales system by the virtual distributor subscription unit 30;
S300: creating a virtual storefront 32 in the virtual distributor subscription unit 30;
S400: selecting products from the database 20 to the virtual storefront 32;
S500: determining a sale price calculated according to a commission over the base price by the virtual storefront 32;
S600: outputting and publishing the virtual storefront 32 to websites by the virtual distributor subscription unit 30;
S700: directing to the intermediary sales system while clicking on the website;
S800: providing business processes wherein a sales transaction is performed by the sales flow unit 40.

Supplier subscription unit 10 enables supplier to subscribe to the ISS1 and make description of products into database 20. Supplier subscription is not paid, and the amount of products submitted to database 20 for free is limited, wherein the limit is determined by supplier subscription unit 10. Supplier who wants to submit more products than this limit will pay per product over a unit wage determined on supplier subscription unit 10.

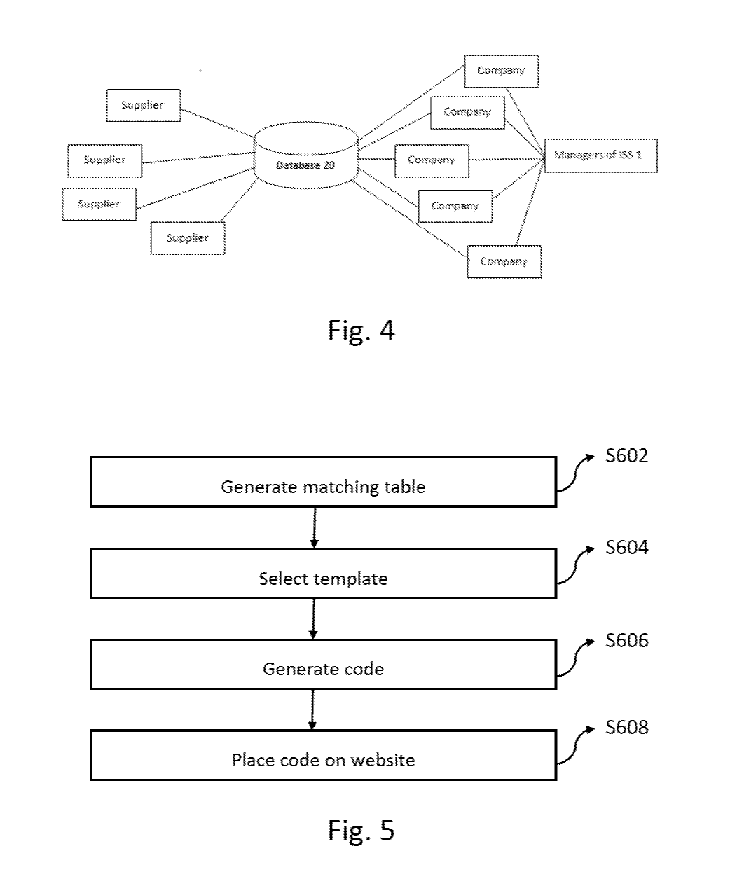

Referring to FIG. 4, database 20 is capable of storing details of products and other related information from supplier subscription unit 10. There are two sources for composing the products into database 20. The first one is that managers of supplier subscription unit 10 who can be virtual managers or people perform descriptions of the companies to which the products belong first, and then the product descriptions with base price and other details of the related companies are made. The second one is that suppliers make product descriptions with initial prices and other details into database 20 through supplier subscription unit 10 first, and then apply a brokerage in a certain ratio on the initial price per product to form the base price. The initial price is the lowest price product can be sold from ISS1 to virtual distributor, and the base price is the lowest price product can be sold from virtual distributor to buyer. In this embodiment, both of the sources are used to submit products and details into database 20 at the same time, while each of the sources can be used alone in other embodiments, which is not limited in this invention.

Virtual distributor subscription unit 30 enables virtual distributors to access database 20, select the products and create a virtual storefront 32. Virtual distributor subscribes to virtual distributor subscription unit 30 first, which enables the virtual distributor to access database 20. Each virtual distributor can start to create a virtual storefront 32 after defining its subscription information in virtual distributor subscription unit 30. Virtual distributor subscription unit 30 enables virtual distributor to make search and filtering in database 20 according to preferences and generates a product catalogue of selected products in virtual storefront 32. The subscription is free for the virtual distributor, and the charging is based on the amount of products the virtual distributor adds to virtual storefront 32. The amount of products the virtual distributor adds to virtual storefront 32 for free is limited, and this free amount is determined by virtual distributor subscription unit 30. The virtual distributor who wants to select more products than this limit has to pay a charge according to the rate determined by virtual distributor subscription unit 30.

Virtual storefront 32 is able to describe commission which virtual distributor will get if the sales transaction is defined for each product. A sale price of product is calculated according to a commission rate to be determined by virtual distributor over the base price, at which the products sold to buyers.

FIG. 5 refers to the flow chart that a virtual distributor publishes products from virtual storefront 32 to its website or other platform. After product selection and price determination steps are completed, a virtual distributor-product matching table is generated for each product by virtual storefront 32 and stored in database 20 (S602). The match table keeps virtual distributor-product match information. Then template selection is made (S604). There are ready templates defined by virtual distributor subscription unit 30 which defines the product advertisement interfaces of customizable virtual storefront 32 that the virtual distributors place on their site. The virtual distributor selects one of these templates with which details of the products are shown, then virtual distributor subscription unit 30 generates an html code (S606). The virtual distributor places the generated html code on its own site or other platform (S608). The bind code also comprises a code having the virtual distributor-product matching information of the virtual storefront as well as products and their details.

Upon buyers visiting the website of the virtual distributor, and upon clicking on a product on the virtual storefront template, buyers are directed to intermediary sales system (ISS 1). After confirming that buyers are directed to ISS 1, virtual distributor-product matching code is processed (S606). This process determines which product and sales steps are presented to the buyer. All necessary sales, shipping, delivery and return processes will be met by sales flow unit 40 after the buyer purchases the product.

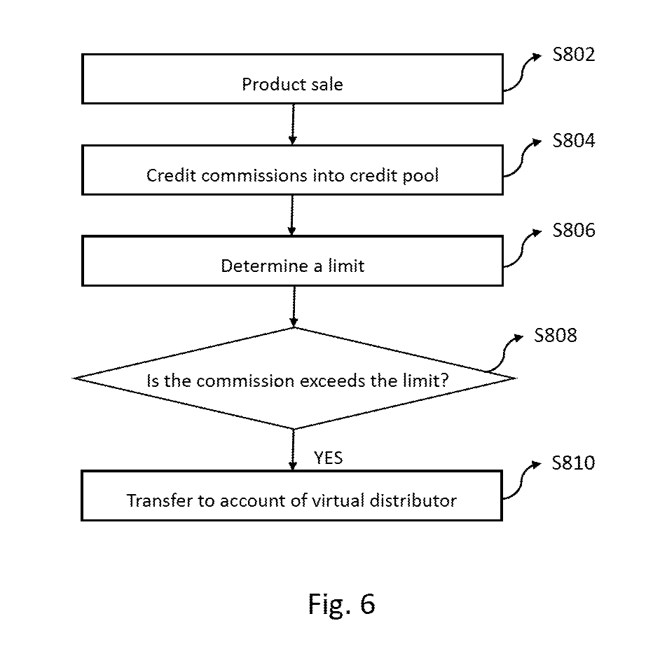

The price of a product can be transferred to the account of the supplier as soon as the product submitted to ISS 1 by the supplier, or after buyer completes the purchase, which is no limited. Referring to FIG. 6, in step S802, after a buyer completes the purchase, commissions are determined by the virtual distributor. This determined amount of commission is credited into credit pool configured in sales flow unit 40 in step S804. A limit of an amount of commissions is determined by sales flow unit 40 in step S806. In step S808, it is checked if the commission exceeds the predetermined limit. If the commission exceeds the limit, then a payment demand is initiated by sales flow unit 40 and sent, to the account of the virtual distributor in step S810.

A computer program is generated and embedded into a non-transitory computer-readable medium to perform the method described above. The computer program configured to cause processor to enable perform the method of intermediated sales, comprising one or more code segments configured the processor to enable suppliers to make descriptions of products into the database; enable virtual distributors to access the database, select the products and create a virtual storefront; and provide business processes wherein sales transaction is performed. One or more code segments are further configured to cause a processor to describe a commission which the virtual distributor gets from sale transaction. One or more code segments are further configured to cause a processor to generate a matching table in the database which is capable of keeping a virtual distributor-product matching information for each selected product. One or more code segments are further configured to cause a processor to define templates with which details of products are shown. One or more code segments are further configured to cause a processor to credit the commissions.

The present invention is to realize a system and method for intermediated selling which enables facilitative communicating among suppliers, virtual distributors and buyers and make commodity sales high efficiency and high profitable. A non-transitory computer-readable medium having embodied thereon a computer program configured to cause a processor to enables a forementioned method be performed is also provided, and code segments are configured to process a forementioned steps. With customizable marketing strategy, virtual distributor has a say in the products what they want to market, the profitability rate that they acquire from the marketing and the sale price of products, therefore the supplier will have more profit similarly as the sharer of the profit obtained by the virtual distributor.

Although the invention has been described and illustrated in detail, it is to be clearly understood that the same is intended by way of illustration and example only and is not to be taken by way of limitation. Accordingly, variations and modifications of the present invention will be apparent to one skilled in the art, and the following claims are intended to cover all such modifications and equivalents.

I claim:

1. A method for intermediated selling via an intermediary sales system, the method comprising the steps of:
storing descriptions of products with base prices into a database;
subscribing to the intermediary sales system;
creating a virtual storefront;
selecting products from the database to the virtual storefront;
determining a sale price calculated according to a commission over the base price;
outputting and publishing the virtual storefront to websites;
directing to the intermediary sales system while clicking on the website; and
providing business processes wherein a sales transaction is performed.

2. The method according to claim 1, wherein an amount of products submitted freely to the database is limited; and a wage is paid for products over the limit.

3. The method according to claim 1, wherein the step of subscribing to the intermediary sales system enables a virtual distributor to access the database.

4. The method according to claim 1, wherein an amount of products added freely to the virtual storefront is limited; and a charging is paid for products over the limit.

5. The method according to claim 1, wherein the step of outputting and publishing the virtual storefront to website comprising the sub-steps of:
keeping a virtual distributor-product matching information in a matching table for each selected product;
selecting a template which defining product advertisement interfaces of the virtual storefront;
generating an html code; and
placing the html code on a website.

6. The method according to claim 5, wherein the html code further comprises a code having, virtual distributor-product matching informations.

7. The method according to claim 6, further comprising processing the virtual distributor-product matching code in the step of directing, to the intermediary sales system.

8. The method according to claim 1, wherein the business processes comprises shipping, delivering and returning.

9. The method according to claim 1, further comprising crediting in the commissions into a credit pool.

10. The method according to claim 9, further comprising transferring to an account of the virtual distributor from the credit pool in case the commissions exceed a limit determined by the intermediary sales system.

11. A system for intermediary selling, comprising:
a database which is capable of storing details of products;
a supplier subscription unit which is capable of enabling suppliers to make descriptions of products into the database;
a virtual distributor subscription unit which is capable of enabling virtual distributors to access the database, select the products and create a virtual storefront; and
a sales flow unit which is capable of providing business processes wherein sales transaction is performed.

12. The intermediary sales system according to claim 11, wherein the virtual storefront is capable of describing a commission which the virtual distributor gets from sale transaction.

13. The intermediary sales system according to claim 11, further comprising a matching table generated into the database which is capable of keeping a virtual distributor-product matching information for each selected product.

14. The intermediary sales system according to claim 11, further comprising templates defined by the virtual distributor subscription unit with which details of products be shown.

15. The intermediary sales system according to claim 14, further comprising a credit pool in the sales flow unit which is capable of crediting in the commissions.

16. A non-transitory computer-readable medium having embodied thereon a computer program configured to cause the processor to enable perform the method of claim 1,
the non-transitory computer-readable medium comprising one or more code segments configured the processor to:
enable suppliers to make descriptions of products into the database;
enable virtual distributors to access the database, select the products and create a virtual storefront; and
provide business processes wherein sales transaction is performed.

17. The non-transitory computer-readable medium according to claim 16, wherein one or more code segments are further configured to cause a processor to: describe a commission which the virtual distributor gets from sale transaction.

18. The non-transitory computer-readable medium according to claim 16, wherein one or more code segments are further configured to cause a processor to: generate a matching table in the database which is capable of keeping a virtual distributor-product matching information for each selected product.

19. The non-transitory computer-readable medium according to claim 16, wherein one or more code segments are further configured to cause a processor to define templates with Which details of products are shown.

20. The non-transitory computer-readable medium according to claim 17, wherein one or more code segments are further configured to cause a processor to, credit the commissions.
